(19) United States
(12) Patent Application Publication
(10) Pub. No.: US 2008/0047784 A1
(43) Pub. Date: Feb. 28, 2008

(54) Door operating mechanism for an automatic door

(75) Inventors: Uwe Krause, Pattensen (DE); Heinz Ludwig, Garbsen (DE); Uwe Nolte, Barsinghausen (DE); Guido Sonntag, Gehrden (DE); Jan Spannberger, Hannover (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/895,547

(22) Filed: Aug. 24, 2007

(30) Foreign Application Priority Data
Aug. 28, 2006 (DE) 10 2006 040 231.6

(51) Int. Cl. B66B 13/08; E05F 15/14

(52) U.S. Cl. 187/316

(57) ABSTRACT

A door operating mechanism for an automatic door is described, in particular for an automatic sliding and/or elevator door. A driving pinion or belt pulley for driving a belt or a chain which is used for transmitting the driving force generated by a motor to the door leaf is mounted to the shaft of the motor. The motor can be aligned with its shaft perpendicular to the opening and closing direction of the door. The door operating mechanism is of particularly compact design, even more so if the motor is an electronically commutated brushless synchronous motor and a magnetic angular encoder embodied as an absolute encoder and resolving 360° is used.

### CROSS REFERENCE TO RELATED APPLICATIONS

This application claims the benefits of German application No. 10 2006 040 231.6 filed Aug. 28, 2006 and is incorporated by reference herein in its entirety.

### FIELD OF INVENTION

The invention relates to a door operating mechanism for an automatic door, in particular for an automatic sliding and/or elevator door, with at least one door leaf, comprising a motor for generating a driving force and a belt or chain guided in the opening or closing direction of the door for transmitting the driving force to the door leaf, the motor being mounted in such a way that its shaft is aligned perpendicular to the opening or closing direction of the door and/or horizontally.

### BACKGROUND OF THE INVENTION

Such door operating mechanisms or similar are known from EP 0 837 536 B11, DE 101 31 211 A1, DE 20 2005 006 404 U1, WO 00/39017 A1 and DE 1953 242 A.

In the field of automatic doors, particularly in the case of elevator doors, it is necessary to make the door operating mechanism as compact as possible, because the door operating mechanism must be mounted so as to be concealed from the elevator user and therefore the installation space for the door operating mechanism also affects the compactness and costs of an elevator system as a whole.

In the case of the door operating mechanism disclosed in DE 101 31 211 A1, a geared motor is present. Gears produce unwanted noise and friction losses leading to rapid wear and costs because of the large number of moving mechanical parts.

### SUMMARY OF INVENTION

The object of the invention is to specify a door operating mechanism which avoids the disadvantages of gears, yet is of compact construction.

With respect to the door operating mechanism referred to in the introduction, this object is achieved according to the invention by an angular encoder for generating an angle signal proportional to the angle of rotation of the motor, said encoder being disposed coaxially to the motor shaft.

This makes possible a particularly compact arrangement that is deflection-free and therefore low-loss in respect of the driving force.

It is particularly advantageous that the motor is disposed - preferably completely inside a door header or lintel at the top of the door, in particular above an elevator car. Ideally no installation space is required above the car of the elevator system for installing or assembling the door operating mechanism. This has specific advantages over a reduction gear solution in which the motor generally has to be mounted above the door header.

In the context of the invention, door header is to be understood as any cross beam rigidly mounted to the door frame, in particular a horizontal section between the lower door system and an upper part, in the case of an elevator the upper part of the car. The door header is generally disposed above the door leaf or leaves.

According to a particularly preferred embodiment, a driving pinion or belt pulley for driving the belt or chain is mounted to the motor shaft.

This has on the one hand the advantage of compactness, on the other, that the belt or chain can be driven gearlessly and/or without reduction gearing by the motor. Gears would significantly increase the axial extent of the overall motor/gear system compared to a gearless drive mechanism. A reduction gear would likewise increase the space requirement, because the driving force would first have to be transmitted from the motor shaft via the reduction gear to an abaxially located double pinion that in turn first drives the belt or chain. The driving pinion or belt pulley is in particular fixed to an unsupported end of the shaft, thereby providing the advantage of universal incorporability into the door system.

The above described mounting of the motor has the further advantage that one and the same motor, e.g. held as a spare part, can be mounted to the door header both at the left- and the right-hand end or anywhere in between, thereby obviating the need to differentiate between left and right output shaft, as is necessary with geared motors.

According to another preferred embodiment, the motor together with driving pinion or belt pulley extends less than 100 mm in the shaft direction, preferably less than 80 mm. In addition, the diameter and/or edge length of the motor is in the range 50 to 200 mm, preferably in the range 80 to 160 mm. With such dimensions, the motor together with driving pinion or belt pulley can be accommodated even in a door lintel or door header having particularly small height and/or width dimensions of less than 110 mm.

Preferably the length of the motor measured without bearing, driving pinion and any electronic components is less than 60 mm, in particular less than 36 mm.

Preferably also, the length of the motor—measured at a distance of at least 35 mm from the shaft—without bearing, driving pinion and any electronic components is less than 60 mm, preferably less than 36 mm.

In another advantageous variant, the motor has a driving torque of at least 0.008 Nm/kg or at least 0.01 Nm/kg door mass, in particular a driving torque in the range 3.0 to 4.5 Nm, preferably in the range 3.5 to 4.0 Nm.

According to another particularly preferred embodiment, the motor is of electronically commutated and/or brushless design, thereby enabling the above mentioned embodiments to be implemented in a particularly advantageous and compact manner.

In an electronically commutated motor, the mechanical commutation system, i.e. the commutator brushes, are replaced by a motor-mounted control unit, also known as a BL controller (brushless controller). In this controller, e.g. a plurality of high-current silicon chips and a programmed microprocessor assume the function of the brushgear, i.e. the wear- and interference-prone interaction of copper segments and carbon brushes.

Dispensing with the brush system has the advantage of reducing noise, the advantage of reducing wear and costs because of a smaller number of moving mechanical parts, and the advantage of eliminating fouling caused by brush abrasion.

The motor is also preferably embodied as a synchronous motor, in particular a permanent-field synchronous motor.

In addition, the door operating mechanism preferably has a control unit with installed control program for moving the door to its open and/or closed position.

In particular, the control unit is designed in such a way that the motor at least during normal operation—is operated at a speed of less than 600 rpm, preferably at a speed of less than 500 rpm.

According to another preferred embodiment, the angular encoder is mounted on the side of the motor facing away from the driving pinion or belt pulley.

According to a preferred embodiment, the angle signal of the angular encoder is used for controlling a commutation circuit for electronic commutation of the motor.

According to another preferred embodiment, the angle signal of the angular encoder is fed as an input variable to a door positioning device.

It is particularly preferred that the angle signal of the angular encoder is used for both of the above-mentioned purposes, resulting in particular savings in respect of installation space, complexity and cost.

For a compact design and in particular for accommodation within the door header or door lintel, it is particularly advantageous that the angular encoder extends max. 40 mm, preferably max. 20 mm, in the axial direction.

It is appropriate for the overall length of motor, driving pinion or belt pulley and angular encoder in the direction of the shaft to be less than 110 mm, or preferably less than 98 mm.

In addition, the angular encoder preferably has a resolution of at least 10 bits/360°, in particular at least 11 bits/360° or at least 12 bits/360°. This is particularly advantageous in conjunction with a low-speed, high-torque motor. In the case of a gearless drive mechanism, a high time resolution is possible even at low rotation speeds, thereby enabling even very low door speeds to be adjusted down to standstill. In addition, the high resolution with a gearless drive mechanism and in particular with sinusoidal control of the motor results in virtually harmonics-free torque development which is characterized by good concentricity with low noise levels.

It is particularly advantageous if the angular encoder is embodied as an absolute encoder.

In the context of the invention, absolute encoder is taken to mean an angle measuring device which outputs position information in the form of a possibly coded numerical value which is unique over the entire resolution range of the absolute encoder, so that no initial reference or calibration pass is necessary, as in the case of an incremental encoder, for example.

The absolute encoder can preferably resolve at least one revolution (360°) completely and is embodied in particular as a single-turn encoder.

An absolute encoder has the advantage over a Hall effect sensor or a quadrature encoder that the rotor position is immediately available at all times, i.e. even immediately after connection of the electricity supply system. This eliminates the hitherto necessary synchronization of the rotor angle on the basis of a reference point or complex calculation. Moreover there is a considerable cost advantage compared to a resolver solution in terms of the encoder itself, but also in respect of the implementation of the control device (control electronics). In addition, less installation space is required compared to a resolver solution.

In addition, an angular encoder is preferably present which employs a magnetic principle and is embodied in particular as a magnetic absolute encoder.

The magnetic absolute encoder or rotary encoder employs in particular the GMR effect. The GMR (giant magneto resistance) effect is a quantum mechanics effect observed in thin film structures made of alternating ferromagnetic and nonmagnetic layers.

Processing is preferably performed in a Wheatstone resistance bridge. This can produce a sine/cosine signal in the two legs of the bridge, thereby enabling each position to be identified through 360°.

The magnetic absolute encoder or angular encoder is alternatively formed by interconnecting a plurality of Hall effect sensors, preferably 3 or 6 Hall sensors. Intelligent processing electronics, e.g. DSP-based, allows unambiguous detection of the entire 360°.

Although using a magnetic absolute encoder for position determination for an automatic door and/or for commutating the motor is particularly advantageous if the driving pinion or belt pulley is mounted directly to the motor shaft, the use of a magnetic absolute encoder for operating or controlling an automatic door is also important independently thereof and must be regarded as an independent solution, as only thus can significant advantages for the door operating mechanism be achieved.

The rotor position is known at each instant i.e. even immediately after application of voltage or current, thereby obviating the need for synchronization of the rotor angle.

Specifically, the high angular resolution produces a high time resolution even at low rotational speeds, so that even very slow door speeds can be adjusted down to a standstill.

Sinusoidal motor control produces virtually harmonics-free torque development which is characterized by very good concentricity with minimal noise.

Low costs.

Low overall height.

### BRIEF DESCRIPTION OF THE DRAWINGS

An exemplary embodiment of a door operating mechanism according to the invention will now be explained in greater detail with reference to FIGS. 1 to 5 in which:

FIG. 1 shows a door for which a door operating mechanism according to the invention can be used,

FIG. 2 shows a front view of an inner area, a so-called door header, in the upper part of the door in FIG. 1,

FIG. 3 shows a plan view of the inner workings of the door header in FIG. 2,

FIG. 4 shows details concerning the electrical design and control of the motor used for the door operating mechanism in FIG. 1, and

FIG. 5 shows further details concerning an angular encoder for controlling the motor used for the door operating mechanism in FIG. 1 and for determining the door position.

### DETAILED DESCRIPTION OF INVENTION

FIG. 1 shows a door 1 of an elevator with two equal-sized door leaves 2, 3 moving in opposite directions. The door 1 is enclosed by a door frame 4 which is terminated and supported at the top by a door header or lintel 5. When the door leaves 2, 3 are open, access to an elevator car 6 positioned therebehind is possible. The opening and closing direction of the door leaves 2, 3 is denoted by 7. The door mass is up to 400 kg.

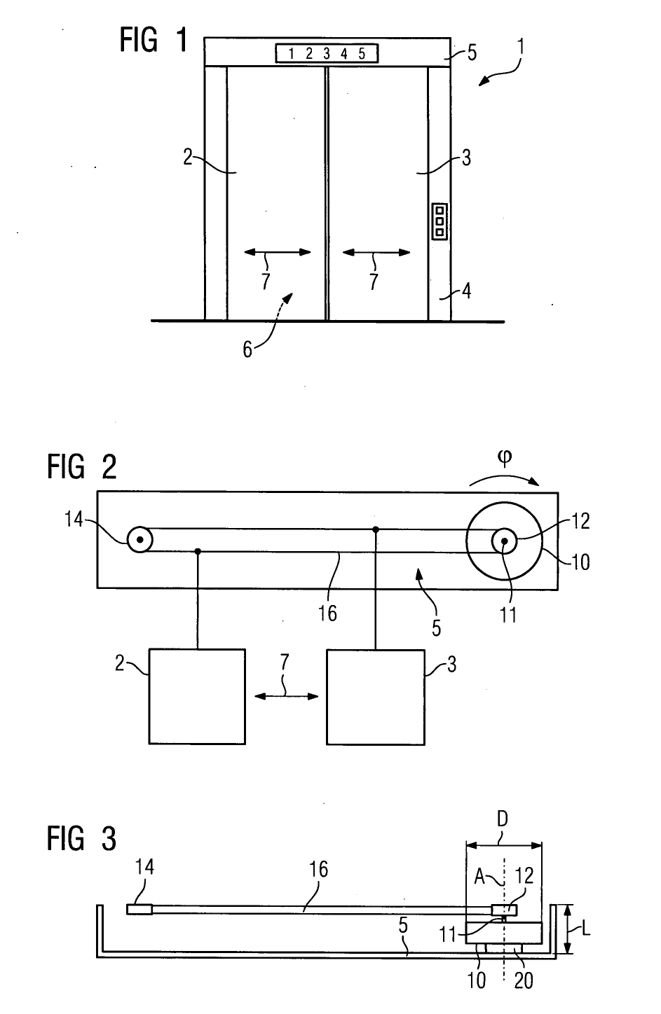

FIG. 2 shows a front elevation of the area of the door header 5, as it would appear if the header cover in FIG. 1 were removed. Inside the door header or lintel 5, an electronically commutated and brushless permanent field synchronous motor 10 is disposed in such a way that its shaft 11 runs perpendicular to the opening and closing direction 7 and horizontally, in FIG. 2 perpendicular to the plane of the drawing. Mounted on the unsupported end of the shaft 11 is a driving pinion, driving pulley or belt pulley 12 or the like. In conjunction with a guide roller 14 mounted at the opposite end of the door header 5, the belt pulley 12 drives a tough elastic toothed belt 16 which transmits the driving force of the motor 10 to the door leaves 2, 3.

FIG. 3 shows the arrangement of FIG. 2 viewed from above. It can be seen that the motor 10 transmits energy gearlessly to the partially rubberized toothed belt 16. The belt pulley 12 sits directly on the shaft 11 of the motor 10. The diameter D of the motor 10 is 160 mm.

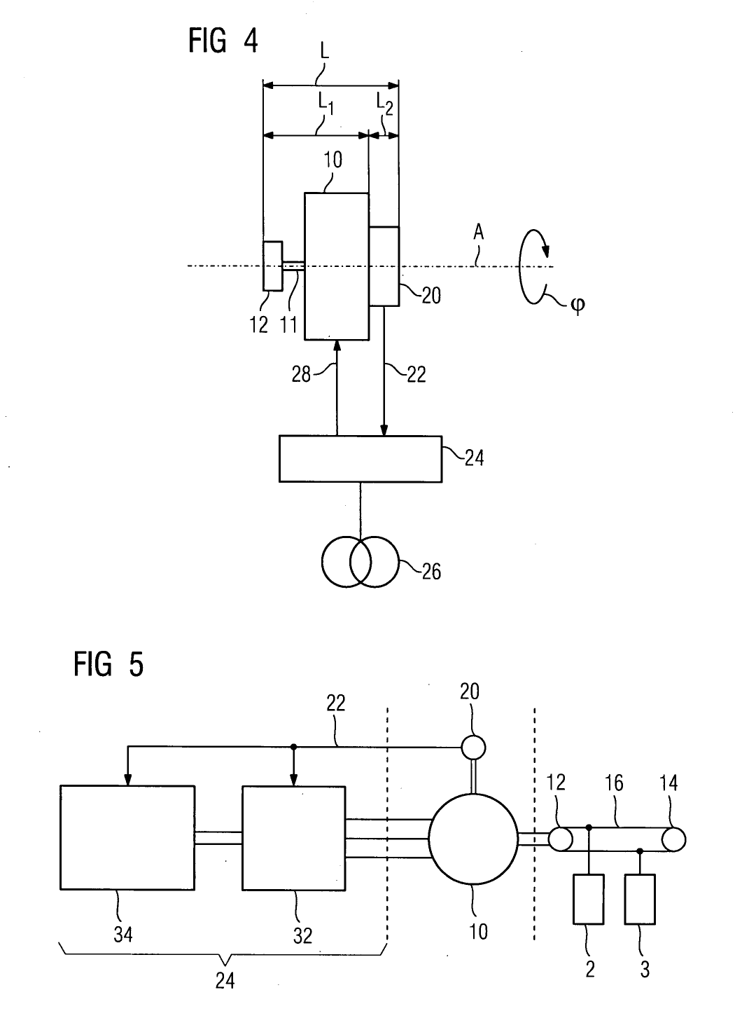

Mounted coaxially to the motor shaft 11, i.e. on the illustrated axis of rotation A of the motor 10, is a magnetic absolute angular encoder 20. This is explained in greater detail in FIG. 4. The depth L of the entire arrangement comprising motor 10, driving pulley 12 and angular encoder 20 is less than or equal to 110 mm. This low-profile design means that the entire arrangement can be accommodated in the door header 5 or lintel with very compact dimensions.

FIG. 4 shows the entire arrangement comprising motor 10, driving pulley 12 and angular encoder 20 in detail and interaction with a control unit 24 assigned to the door operating mechanism. Not only the motor 10 but also the angular encoder 20 is of particularly low-profile design:

Depth L₂ of the angular encoder 20: approx. 30 mm.

Depth L₁ of the motor 10 and driving pulley 12 together: approx. 80 mm.

Overall depth or overall length L: less than 110 mm.

The angular encoder 20 is located on the side of the motor 10 facing away from the driving pulley 12 and is mounted centrally with respect to the axis A of the motor 10. The angle of rotation (p is indicated in the Figure. The control unit 24 supplies the motor 10 with power in a controlled and regulated manner from a power source 26 such as the public AC supply via a line 28. The angular encoder 20 communicates an analog or coded numerical angle value to the control device 24 via a line 22. The resolution of the combination of angular encoder 20 and control unit 24 is 12 bits, producing an angular resolution of 360°/4096=0.09° for 360°.

FIG. 5 is a block diagram showing in detail how the angle signal 22 of the angular encoder 20 is simultaneously used for different purposes:

The control device 24 of the door operating mechanism has a commutation circuit 32 for electronically commutating and/or sinusoidally modulating the motor 10 embodied as a synchronous or an asynchronous motor. The angle signal 22 is fed to the commutation circuit 32. The high resolution of the angular encoder 20 is fully required for this purpose. This arrangement is particularly advantageous for an electronically commutated (EC) and brushless permanent field synchronous motor 10, preferably gearless, because there is a considerable price advantage compared to rotary resolvers (synchros) used for commutation with identical functionality. In the case of an EC motor the commutation circuit 32 can be termed a BL controller.

The control device 24 of the door operating mechanism additionally has, as a functional unit a door positioning device 34 to which the angle signal 22 is likewise fed. The door positioning device 34 controls the door status and/or the door position. With the numerical angle value, the position of the door leaves 2 and 3 is known via the diameter of the driving pinion 12 used, so that the control unit 24 or the door positioning device 34 can perform service runs to the open or closed position or service test runs in the known manner to determine such end positions. A low and not the full resolution of the angular encoder 20 is required for this purpose.

1.-24. (canceled)

25. A door operating mechanism for an automatic sliding door having a door leaf, comprising:
a motor having a shaft for generating a driving force wherein the motor is mounted such that the shaft is aligned perpendicular to an opening and closing direction of the door and/or horizontally;
a belt or chain guided in the opening and closing direction of the door for transmitting the driving force to the door leaf; and
an angular encoder for generating an angle signal proportional to the angle of rotation of the motor arranged coaxially to the motor shaft.

26. The door operating mechanism as claimed in claim 25, wherein a driving pinion or belt pulley for driving the belt or chain
is mounted to the shaft of the motor, or
is attached to an unsupported end of the shaft.

27. The door operating mechanism as claimed in claim 26, wherein the belt or chain is driven gearlessly and/or without reduction gears by the motor.

28. A door operating mechanism as claimed in claim 27, wherein the motor is disposed completely inside a door header or lintel above a car of the elevator.

29. A door operating mechanism as claimed in claim 28, wherein the motor and associated drive pinion or belt pulley has an extent of less than 100 mm, in the shaft direction.

30. A door operating mechanism as claimed in claim 29, wherein the length of the motor measured at a distance of at least 35 mm from the shaft excluding bearing, drive pinion and any electronic components is less than 60 mm.

31. A door operating mechanism as claimed in claim 30, wherein the motor is of electronically commutated and/or brushless design.

32. A door operating mechanism as claimed in claim 31, wherein the diameter and/or the edge length of the motor ranges between 50 and 200 mm.

33. A door operating mechanism as claimed in claim 32, wherein the motor is a permanent field synchronous motor.

34. A door operating mechanism as claimed in claim 33, wherein the motor is designed for a driving torque of at least 0.008 Nm/kg or a door mass of at least 0.01 Nm/kg.

35. A door operating mechanism as claimed in claim 34, further comprising a control device with installed control program for moving the door to its open and/or closed position.

36. The door operating mechanism as claimed in claim 35, wherein the control device is designed such that the motor during normal operation is operated at a speed of less than 600 rpm,.

37. A door operating mechanism as claimed in claim 36, wherein an angle signal of the angular encoder is used to control a commutation circuit for electronically commutating the motor, and the angle signal of the angular encoder is fed as an input variable to a door positioning device.

38. A door operating mechanism as claimed in claim 37, wherein the angular encoder has a resolution of at least 10 bits/360.

39. A door operating mechanism as claimed in claim 38, wherein the angular encoder has a maximum extent in the axial direction of 40 mm.

40. A door operating mechanism as claimed in claim 39, wherein the overall length of motor, driving pinion or belt pulley and angular encoder in the shaft direction is less than 110 mm.

41. A door operating mechanism as claimed in claim 40, wherein the angular encoder is an absolute encoder.

42. A door operating mechanism as claimed in claim 41, wherein the angular encoder is a magnetic absolute encoder that employs the GMR effect.

43. The door operating mechanism as claimed in claim 42, wherein the angular encoder comprises an interconnection of a plurality of Hall effect sensors.

44. A door operating mechanism as claimed in claim 43, wherein the angular encoder is a single-turn encoder.
